(19) United States
(12) Patent Application Publication
(10) Pub. No.: US 2025/0060704 A1
(43) Pub. Date: Feb. 20, 2025

(54) COMPUTER-GENERATED HOLOGRAPHIC DISPLAY SYSTEM

(71) Applicant: VividQ Limited, London (GB)

(72) Inventors: Mark BRANNAN, London (GB); Alfred James NEWMAN, London (GB)

(21) Appl. No.: 18/939,282

(22) Filed: Nov. 6, 2024

Related U.S. Application Data
(63) Continuation of application No. PCT/GB2023/051388, filed on May 26, 2023.

(30) Foreign Application Priority Data
May 27, 2022 (GB) 2207882.8

(51) Int. Cl. G03H 1/22

(52) U.S. Cl. CPC G03H 1/2205; G03H 1/2294; G03H 2001/2207; G03H 2223/50

(57) ABSTRACT

Computer-generated holographic display systems are described with improved image quality when used with illumination sources other than single mode lasers, such as broader emission light sources including LEDs and multi-mode lasers.

### CROSS-REFERENCE TO RELATED APPLICATIONS

This application is a continuation under 35 U.S.C. § 120 of International Application No. PCT/GB2023/051388, filed May 26, 2023 which claims priority to United Kingdom Application No. GB 2207882.8, filed May 27, 2022, under 35 U.S.C. § 119 (a). Each of the above-referenced patent applications is incorporated by reference in its entirety.

### TECHNICAL FIELD

The present invention relates to a holographic display system.

### BACKGROUND

Holographic display systems, also referred to as Computer-Generated Hologram (CGH) display systems include depth information when displaying images, for example by preserving wavefront information, presenting a number of advantages. For example, the vergence accommodation conflict in conventional displays is reduced or eliminated: a viewer can focus naturally on a CGH image, or part of a CGH image, at a perceived depth.

It is necessary for a CGH display to use a light source which is at least partially coherent. It is known that the coherence of the light source influences the resultant image quality, such as the image sharpness, but this relationship is not well understood.

It is generally assumed that the use of broad emission light sources, such as Light Emitting Diodes (LEDs) in a CGH display introduces a loss of resolution in the displayed image. The paper Deng, Y., Chu, D. “Coherence properties of different light sources and their effect on the image sharpness and speckle of holographic displays.” Sci Rep 7, 5893 (2017) available from https://doi.org/10.1038/s41598-017-06215-x, discusses how a temporal coherence of a light source influences image speckle and a spatial coherence of a light source influences image sharpness. Simulation and experimental results of different light sources are presented. A single mode laser source has high spatial coherence for good image sharpness, but also a high temporal coherence which introduces unwanted speckle into the image. Deng et al conclude that a light source with high spatial coherence (for good sharpness) and low temporal coherence (for low speckle) is ideal for a holographic display. They suggest the use of a Superluminescent Light Emitting Diode, (SLED or SLD) or micro Light Emitting Diode (mLED) as suitable light sources but do not otherwise characterise the light source.

Deng et al notes that the spatial coherence of an LED can be improved using spatial filtering, such as a pin hole, between the light source and the SLM but explains that this reduces the efficiency. The paper ends with a note that future work needs to be carried out to improve the spatial coherence of an LED while maintaining its good light efficiency.

It would be desirable to improve at least one aspect of the image quality of a CGH display when used with light sources other than single mode lasers, such as broader emission light sources including LEDs and multi-mode lasers.

### SUMMARY

The inventors have a new approach to quantifying the effects of broader emission sources on image quality. By considering the contribution to a Point Spread Function (PSF) of a CGH display after the SLM, it is possible to define limits on the illumination system properties for improved image quality-particularly image sharpness—with more specificity. A general result of this analysis is that the acceptable source bandwidth (both spatial, such as a source emission area or etendue, and temporal, such as a range of wavelengths present in the output) emitted by illumination system is inversely proportional to the distance between the reimaged SLM as viewed by a viewer and a virtual image point perceived by viewing the reimaged SLM. For example, it may be beneficial to design a holographic display system to re-image an SLM some distance away from a viewer, in a plane that is separated from the viewed image content by a low number of dioptres, such as 4 dioptres or less, 3 dioptres or less, or 2 dioptres or less. Having established this relation, characteristics of the illumination source and/or optical system can then be defined to give acceptable resolution and/or improved efficiency when used with broad bandwidth sources, such as an LED or a multimode laser. For example, limits on illumination source etendue and/or spectral bandwidth can be specified in a way not previously understood and then used to select a particular illumination source and/or optimise the system design for improved efficiency. Deng et al does not consider or recognise how reimaging an SLM at a distance from a viewer can influence image quality, its proposed systems reimage the SLM substantially coincident with a plane of viewer's pupil, i.e., at zero distance from the viewer

According to a first aspect, a computer-generated holographic, CGH, display system, also referred to as a computer-generated hologram display system or simply a holographic display system, has an angular resolution and an angular field of view at a viewing position. The CGH display system comprises: an illumination system comprising an LED or multi-mode laser; an SLM illuminated by the illumination system; and an optical system configured to reimage the SLM at a predetermined distance from the viewing position. The illumination system has an etendue at the SLM which is less than or equal to a product of the angular resolution and the angular field of view divided by a maximum focal power of a virtual image point with respect to the reimaged SLM. The angular resolution is less than about 1 mrad. Expressed mathematically, θᵣₑₛₒₗᵤₜᵢₒₙ<≈1 mrad. While pixelation will be visible, this may be acceptable for some uses. As the numerical value of the angular resolution becomes smaller, the pixelation becomes less visible and so image quality increases. In other words, the angular resolution may be better/no worse than about 1 mrad, which corresponds to about 17.5 pixels per degree. Other systems may have the angular resolution <0.9 mrad, <0.7 mrad, <0.6 mrad, <0.5 mrad, <0.4 mrad and <0.3 mrad.

In this way, the characteristics of the CGH display system may inform the properties of the illumination system, allowing an informed choice of illumination source without compromising the angular resolution. Similarly, properties of the illumination system may inform the properties of the optical system to improve efficiency of a particular illumination system.

It will be appreciated that in some embodiments the illumination system may comprise more than one LED and/or more than one multimode laser.

Reference to properties of the illumination system refer to the light emitted by the illumination system incident on the SLM, which need not necessarily be the same as properties of an illumination source forming part of the illumination system. The illumination system may comprise at least one illumination source. In some examples the illumination system may consist of the at least one the illumination source used directly. It is the etendue at the SLM, or incident at the SLM, which is important. Other examples of the illumination system may comprise components in addition to the at least one illumination source. The components may comprise filters, such as spatial filters, angular filters, and spectral filters, and fibers, such as a multi-mode fiber, which at least partially alter the emission of the illumination system. For example, an emission area of an illumination source may be reduced by a spatial filter, an emission spectrum of an illumination source may be reduced by a spectral filter, an emission cone of an illumination source may be reduced by an angular filter, and a single-mode illumination source may be converted to a multi-mode illumination source by an optical fiber. The additional components may be combined, for example to define an emission area and emission cone.

The viewing position may be the position of a viewer's pupil in use, so the angular resolution and the angular field of view may both be expressed at the position of a viewer's pupil. The angular resolution may be expressed as the angular extent of the smallest detail from the viewing position.

Etendue is a property known to the skilled person. For simplicity, in this disclosure the term is used to refer to etendue in a single dimension (i.e., a length multiplied by an angle). The same analysis may be followed in two dimensions, considering the extent of the source in x and y, where etendue is then defined by an area multiplied by a solid angle. The etendue of an illumination system can be calculated by multiplying a width of the SLM by an angular subtense of the illumination source at the SLM. Angular subtense can be calculated from knowledge of emission characteristics such as directly from a datasheet of an illumination source, or by measurement such as using a camera positioned with its entrance pupil at the location of the SLM. Deng et al recognises that spatial filtering an extended source, such as a LED, can improve image quality, but does not identify any further quantifiable relationship. Deng's spatial filtering reduces the area but does not consider etendue. By shifting the position of the re-imaged SLM away from a viewer's pupil, quantifiable limits on the illumination system etendue can be set. In contrast, Deng et al teaches that the SLM should be reimaged at the pupil (sometimes referred to as a “pupil plane” architecture).

Etendue of a broad bandwidth source, such as a LED, can be reduced by filtering. The filtering can be one or both of spatial filtering (reducing the effective emission area of an illumination source) and angular filtering (reducing the effective emission cone angle of an illumination source). Knowledge of the maximum etendue allows the efficiency of the system to be improved with minimal impact on resolution. For example, the filtering may be chosen to reduce the illumination system etendue incident on the SLM so that the etendue is substantially equal to 100% of the product of the angular resolution (θᵣₑₛₒₗᵤₜᵢₒₙ) and the angular field of view (θ_{FOV}) divided by the maximum focal power (Dₘₐₓ) of a virtual image point with respect to the reimaged SLM. (Substantially equal to 100% of (θᵣₑₛₒₗᵤₜᵢₒₙ θ_{FOV})/Dₘₐₓ. This can improve efficiency without adversely impacting resolution.

The illumination system etendue may be at least 2%, at least 5%, at least 10%, at least 20% or at least 50% of (θᵣₑₛₒₗᵤₜᵢₒₙ θ_{FOV})/Dₘₐₓ.

Focal power is well known. The maximum focal power, Dₘₐₓ, can be calculated for the CGH display system as the (d_{SLM}−d_{obj})/(d_{obj} d_{SLM}), where d_{SLM} is the distance of the reimaged SLM from a viewer and d_{obj} is the distance of a closest virtual object to a viewer.

In some examples, the illumination system comprises a Light Emitting Diode, LED, a superluminescent Light Emitting Diode, sLED or a micro Light Emitting Diode, mLED.

The predetermined distance may be greater than a minimum distance of a virtual image point from the viewing position. This positions the reimaged SLM further from the viewing position than the closest virtual image point and assists with reducing the maximum focal power required. For example, the SLM may be reimaged at least 1 m, or at least 0.5 m from the viewing position. In some examples, the predetermined distance may be negative, corresponding to a position of the reimaged SLM behind the viewer, such as will happen if the SLM is reimaged “beyond infinity”.

In some cases, the maximum focal power corresponds to a virtual image point less than or equal to about 1 m from the viewing position. For example, the maximum focal power may correspond to a closest virtual image point to the viewing position presented by the CGH display in use.

In some examples, the maximum focal power corresponds to a virtual image point approximately 0.25 m from the viewing position. 0.25 m is generally accepted as the closest focusing distance of the human eye, so this is useful for headset based displays, such as for virtual reality or augmented reality.

The maximum focal power may be less than or equal to about 4 dioptres, less than or equal to about 3 dioptres, less than or equal to about 2 dioptres or less than or equal to about 1 dioptre. The inventors have found that maximum allowable illumination system etendue for a given angular resolution is inversely proportional to the maximum focal power. A smaller maximum focal power advantageously allows a larger etendue and hence a wider possible choice of possible illumination sources and/or reduced filtering in the illumination system, which may improve efficiency.

The angular resolution may be greater than about 0.15 mrad. Expressed mathematically, θᵣₑₛₒₗᵤₜᵢₒₙ>≈0.15 mrad. As the numerical value of θᵣₑₛₒₗᵤₜᵢₒₙ increases, the size of points/pixels becomes larger so that pixelation increases and image quality decreases. In other words, the angular resolution may be worse/no better than about 0.15 mrad corresponds to about 6,700 points per radian and generally corresponds to the resolving limit of the human eye. As the allowable etendue is proportional to angular resolution, setting the numerical value of the angular resolution to be greater than about 0.15 mrad means that the allowable etendue can be maximised without providing a system that has a pixel size smaller than the human eye can resolve. Other systems may have larger angular resolutions, for example angular resolution >0.2 mrad, >0.3 mrad, >0.4 mrad, >0.5 mrad, >0.6 mrad, >0.7 mrad, >0.8 mrad and >1 mrad.

So far only the etendue of the illumination system has been considered. Broad bandwidth sources typically also have a spectral bandwidth, in other words they emit a range of wavelengths rather than a single wavelength. This also influences image quality. In some embodiments, the CGH display system has a limiting aperture width; the illumination system has a spectral bandwidth, Δλ, and a nominal wavelength, λ; and the spectral bandwidth divided by the nominal wavelength is less than or equal to angular resolution, θᵣₑₛₒₗᵤₜᵢₒₙ, divided by the product of the maximum focal power, Dₘₐₓ, and the limiting aperture width, w_{eyebox}. In other words, Δλ/λ is less than or equal to θᵣₑₛₒₗᵤₜᵢₒₙ/(Dₘₐₓ w_{eyebox}). This provides a limit on the spectral bandwidth to maintain reasonable image resolution and can allow sources such as LEDs to be used.

As noted by Deng et al speckle noise can be reduced by sources with higher spectral bandwidth (a low temporal bandwidth), such as LEDs. However, Deng does not provide any limits for acceptable image quality, beyond a general observation that higher spectral bandwidth reduces image sharpness at the same time as reducing speckle noise. By shifting the reimaged SLM away from the viewing position it is possible to quantify the acceptable spectral bandwidth for a given resolution of the display without unduly affecting the angular resolution.

Some examples may apply tighter limits on the source spectral bandwidth divided by the nominal wavelength (Δλ/λ). For example, a value of Δλ/Δ less than 100%, less than 90%, less than 75% or less than 50% of θᵣₑₛₒₗᵤₜᵢₒₙ/(Dₘₐₓ w_{eyebox}) has successively less impact on angular resolution. Some examples may have Δλ/λ at approximately 100% of θᵣₑₛₒₗᵤₜᵢₒₙ/(Dₘₐₓ w_{eyebox}). This could be advantageous when designing an optical system to make full use of the spectral bandwidth, for example to improve efficiency and/or to reduce speckle noise.

Source spectral bandwidth can be measured as the conventional Full Width Half Maximum (FWHM) method, whereby the spectral bandwidth is measured between wavelengths at points which have half the intensity of the wavelength having maximum intensity.

While it is possible to use an illumination source directly, without adjusting its spectral bandwidth, some examples may include a spectral filter to limit the spectral bandwidth, such as a spectral filter that only allows limited wavelengths to pass through. Spectral filters with defined nominal and FWHM characteristics are commercially available, such as from Thor Labs. Spectral filters may allow broader spectral bandwidth sources to be used than would otherwise be possible. Spectral filters may be provided as part of the illumination system, filtering the light spectral bandwidth before the light is incident on the SLM, or provided separately after the SLM.

The limiting aperture is the aperture of the smallest pupil in the system. This may be the exit pupil of the display itself. The inventors have shown that acceptable spectral bandwidth is inversely proportional to the size of the limiting aperture, so it can be advantageous to keep the limiting aperture small. In some examples, the limiting aperture width is less than about 7 mm. 7 mm is roughly the diameter of a human pupil. When the display system itself has a larger limiting aperture, the viewer's pupil can then form the limiting aperture, so in some examples 7 mm may be used rather than the limiting aperture.

As discussed above, limits on spectral bandwidth provided in combination with limits on etendue. The limits on spectral bandwidth can also be applied in isolation of the limits on etendue. In another aspect a CGH display system has an angular resolution at a viewing position and a limiting aperture width. The CGH display system comprises: an illumination system comprising an LED or multi-mode laser and having a spectral bandwidth and a nominal wavelength; an SLM illuminated by the illumination system; and an optical system configured to reimage the SLM at a predetermined distance from the viewing position. The spectral bandwidth divided by the nominal wavelength is less than or equal to the angular resolution divided by the product of the limiting aperture width and a maximum focal power of a virtual image point with respect to the reimaged SLM. The angular resolution is less than about 1 mrad.

In another aspect a CGH display system has an angular resolution at a viewing position. The CGH display system comprises: an illumination system comprising an LED or multi-mode laser and having a source spectral bandwidth and a nominal wavelength; an SLM illuminated by the illumination system; and an optical system configured to reimage the SLM at a predetermined distance from the viewing position. The source spectral bandwidth divided by the nominal wavelength is less than or equal to the angular resolution divided by the product of 7 mm and a maximum focal power of a virtual image point with respect to the reimaged SLM. The angular resolution is less than about 1 mrad.

In a further aspect, the contribution to the PSF due to one, some or all of (i) a spectral bandwidth of the illumination system, (ii) an angular subtense of light incident on the SLM, and (iii) a dimension of the source, such as a diameter are kept less than the contribution due to the inherent resolution of the SLM up to a predetermined maximum distance from the SLM. It will be appreciated that there are many design solutions with these constraints that can lead to a variety of different ways of defining and/or limiting characteristics of the illumination system to meet this solution. However, the skilled person can readily determine these various designs from their knowledge of the way in which each component influences the PSF, as explained in more detail later. The predetermined maximum distance imposes a constraint so that the respective contributions can be determined. For example, by determining the contribution to the PSF from the SLM at the predetermined maximum distance and then using that to derive the constraints on the illumination system to ensure that the contribution from the spectral bandwidth, angular subtense and dimension of the source at the maximum distance are not substantially more than the contribution from the SLM.

Applying more constraints to characteristics can control various influences on the sharpness of the image. There are benefits to constraining only one of the spectral bandwidth, angular subtense or source dimension. These benefits improve when more than one is applied and a good balance is obtained by applying the constraint to spectral bandwidth and angular subtense, but the invention is not limited to this combination.

According to an aspect, there is provided a CGH display system comprising: an illumination system comprising a Light Emitting Diode, LED, or multi-mode laser; and a Spatial Light Modulator, SLM, illuminated by the illumination system. The CGH display system is configured to display images within some focal power of an image of the SLM that is relayed to the viewer. This corresponds to displaying images within a predetermined maximum distance from the SLM, which is less than approximately 50 mm. Up to the predetermined maximum distance (i) a spectral bandwidth and (ii) an angular subtense of light incident on the SLM each has a respective contribution to a combined point spread function of light leaving the SLM which is less than or equal to a contribution due to an inherent resolution of the SLM. Other examples may apply a less strict criteria, such as up to the predetermined maximum distance (i) a spectral bandwidth and (ii) an angular subtense of light incident on the SLM each has a respective contribution to a combined point spread function of light leaving the SLM which is less than or equal to twice or four times the contribution due to an inherent resolution of the SLM

This makes use of the fact that the contribution to the PSF from the inherent resolution of the SLM, spectral bandwidth, and angular subtense is additive in quadrature. It has been found that good image quality is obtained by keeping the contribution from spectral bandwidth and angular subtense less than or equal to the contribution from the inherent resolution of the SLM. All of these quantities can readily be determined by the person of skill in the art for a particular display configuration. In this way, good image quality can be obtained while using illumination sources other than a single mode laser, such as LED or multi-mode lasers. (It will be appreciated that a multi-mode laser could itself comprise a single mode laser which is converted into multi-mode using an additional device, such as by passing it through an optical fibre. In this case the illumination system comprises a multi-mode laser by virtue of this conversion into a multi-mode laser.)

By specifying the predetermined maximum distance for imaging from the SLM, it is possible to define qualitatively characteristics of the illumination system in a way not previously possible. More specifically, limits on characteristics of the illumination system can be defined before the source becomes a significant limiting factor on resolution. It will be understood that this does not mean that any multi-mode laser or LED source can be used, but the acceptable bounds are such that many more sources can be used.

Several potential advantages may result, including one or more of: the ability to use higher power and/or lower cost multi-mode laser sources; the ability to use cheaper LED sources; and reduced laser safety risks for a given optical power.

In some examples, the spectral bandwidth is greater than 1 nm. Additionally, or alternatively, the spectral bandwidth may not be practically constrained. This can reduce costs by allowing wider bandwidth sources to be used in the illumination system than single mode lasers. If an upper bound is used, then the impact of the spectral bandwidth on reducing image sharpness is controlled so as to be less noticeable.

The predetermined maximum distance may be less than approximately 50 mm, less than approximately 25 mm, or less than approximately 10 mm. Setting a smaller value for the maximum distance increases the allowable spectral bandwidth of the illumination system, so that a wider range of illumination sources can be used.

In some examples, the illumination system comprises a Light Emitting Diode, LED, a Superluminescent Light Emitting Diode, sLED or a micro Light Emitting Diode, mLED.

The spectral bandwidth of the illumination system, Δλ, may be limited according to the following equation

$$Δ λ \leq \frac{{p}^{2}}{{d}_{max}}$$

where p is a pixel pitch of the SLM and dₘₐₓ is the predetermined maximum distance. In words: the spectral bandwidth may be less than or equal to the square of the pixel pitch, divided by the predetermined maximum distance.

The illumination system may be configured such that light diverges from the SLM at an angular subtense, θ; and

$$θ \leq \frac{p}{{d}_{max}}$$

where θ is the angular subtense in radians, p is a pixel pitch of the SLM and dₘₐₓ is the predetermined maximum distance. In words: the angular subtense is less than a pixel pitch of the SLM divided by the predetermined maximum distance.

The system may comprise a collimating lens having a focal length f_{c} positioned between the illumination system and the SLM, wherein the illumination system is configured such that

$$ϕ \leq \frac{p {f}_{c}}{{d}_{max}}$$

where Φ is the diameter of light emitted by the illumination system, p is a pixel pitch of the SLM and dₘₐₓ is the predetermined maximum distance. In words: the diameter of light emitted by the illumination system is less than twice the pixel pitch of the SLM multiplied by the focal length of the collimating lens divided by the predetermined maximum diameter. A diameter is referred to because most light sources approximate a circle in their emission pattern, it will be appreciated that where a source is not circular, a longest dimension of their emission area may be considered to be a diameter when setting the constraints on the illumination system.

The system may comprise a lens having a focal length after the SLM and the predetermined maximum distance is based on the focal length of the lens.

According to a further aspect of the present invention, there is provided a head mounted display comprising a CGH display system according to any of the above-described aspects, with or without the optional features also described.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows an example viewing scheme for a CGH display, illustrating the effects of source etendue, where an SLM is reimaged some distance from a viewer;

FIG. 2 shows an example viewing scheme for a CGH display illustrating effects of spectral bandwidth of the source, where an SLM is reimaged some distance from a viewer;

FIG. 3 shows an example CGH display system in which the principles of this disclosure can be implemented.

FIG. 4 shows an example of how an angular subtense contributes to the point spread function of the display system;

FIG. 5 shows an example of how spectral bandwidth contributes to the point spread function of the display system;

FIG. 6 shows the effect of a relay lens in the CGH display system of FIG. 3; and

FIG. 7 is a flow chart of an example method to determine illumination system characteristics.

### DETAILED DESCRIPTION

The present disclosure considers contributions to a Point Spread Function (PSF) at a viewing position to allow the impact of broad bandwidth sources (such as in terms of spectral bandwidth and etendue) on image resolution of a computer-generated hologram display (hereafter also referred to as a “holographic display”) to be understood. From this analysis various relations can be determined to improve the design of CGH displays.

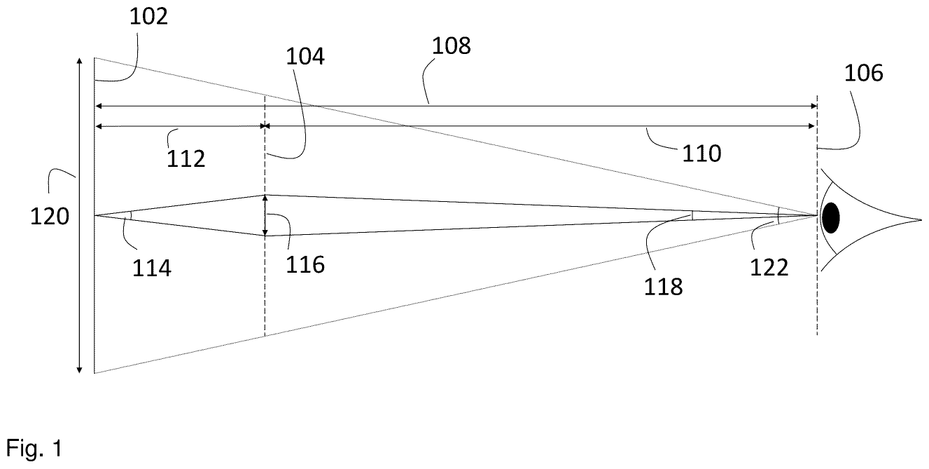

FIG. 1 shows a generic viewing scheme for a CGH display, comprising: an image of an SLM, 102; a virtual image point that is viewed as part of the displayed image, the point being in a plane 104; and a viewer, viewing from a plane 106. The image of the SLM is at some distance, d_{SLM}, from the viewer, shown as 108; a virtual image point is at distance, d_{obj}, from the viewer shown as 110. The distance between the re-imaged SLM and a virtual object, Δd is also shown, shown as 112.

The location of the virtual object is described as being some focal power away from the plane of the SLM, where the focal power D is defined by D=(d_{SLM}−d_{obj})/(d_{SLM} d_{obj}), with units of dioptres.

Note that in FIG. 1 the image of the SLM is shown as being at a finite distance in front of the viewer for simplicity. However, the SLM may be reimaged at infinity, or ‘beyond infinity’, meaning the position of the virtual image has wrapped around and is behind the viewer and is d_{SLM} negative. In cases such as these the following analysis is still applicable.

Due to the extended nature of the source, light at the image of the SLM has some angular subtense, θ_{SLM}, shown as 114. This results in the PSF in the plane of the object having some width, wₛₚₐₜᵢₐₗ, shown as 116. Working in the small angle approximation:

wₛₚₐₜᵢₐₗ≈Δd·θ_{SLM}.

This results in a PSF as seen by the viewer having some angular width θₛₚₐₜᵢₐₗ, shown as 118. θₛₚₐₜᵢₐₗ represents the contribution to the overall angular psf due to the limited spatial coherence of the source.

Also shown is the width of the image of an SLM, w_{SLM}, shown as 120, and the angular field-of-view, θ_{fov}, shown as 122. In other words, w_{SLM} is the apparent width of the SLM as viewed from plane 106, such as the width of an image of the SLM when viewing the SLM through an optical system positioned between the SLM and the plane 106.

Conservation of etendue from light source to SLM means that the product of θ_{SLM} and w_{SLM}, which we denote G, is the same as the product of the angular width of the source, θ_{source}, with the width of the source, w_{source}. Put another way:

$${w}_{SLM} = ( {θ}_{S L M} . {w}_{source} ) / {θ}_{s o u r c e}$$

Note that the extent of the source here is defined as being the extent of light incident on the SLM—e.g., if the source is spatially or angularly filtered then those dimensions define the extent of the source. For simplicity, in this description G denotes etendue in a single dimension (i.e., a length multiplied by an angle). The same analysis may be followed in two dimensions, considering the extent of the source in x and y, where G is then defined by an area multiplied by a solid angle.

We now proceed to show that the etendue of the source, G, can be specified in terms of θₛₚₐₜᵢₐₗ, θ_{fov} and D: i.e., for a display specified to have a given angular resolution, field of view, and where objects are displayed within some focal power of the SLM, the maximum permissible source etendue can be specified.

Working in the small-angle approximation (sin x≈tan x≈x), we can write

$${θ}_{spatial} = {w}_{spatial} / {d}_{obj}$$

$$and$$

$${w}_{spatial} = Δ d . {θ}_{SLM} = ( {d}_{SLM} - {d}_{obj} ) {θ}_{SLM}$$

$$also$$

$${θ}_{SLM} = G / {w}_{SLM} = G / ( {d}_{S L M} . {θ}_{fov} ) .$$

Putting this together we obtain:

$${θ}_{spatial} = \text{} ( {d}_{SLM} - {d}_{obj} ) {θ}_{SLM} / {d}_{obj} = G ( {d}_{SLM} - {d}_{obj} ) / ( {d}_{obj} . {d}_{SLM} . {θ}_{fov} ) = G . D / {θ}_{fov}$$

So, expressing this in terms of source etendue for a given θₛₚₐₜᵢₐₗ we obtain:

$$G = {θ}_{spatial} {θ}_{fov} / D \qquad ( 1 )$$

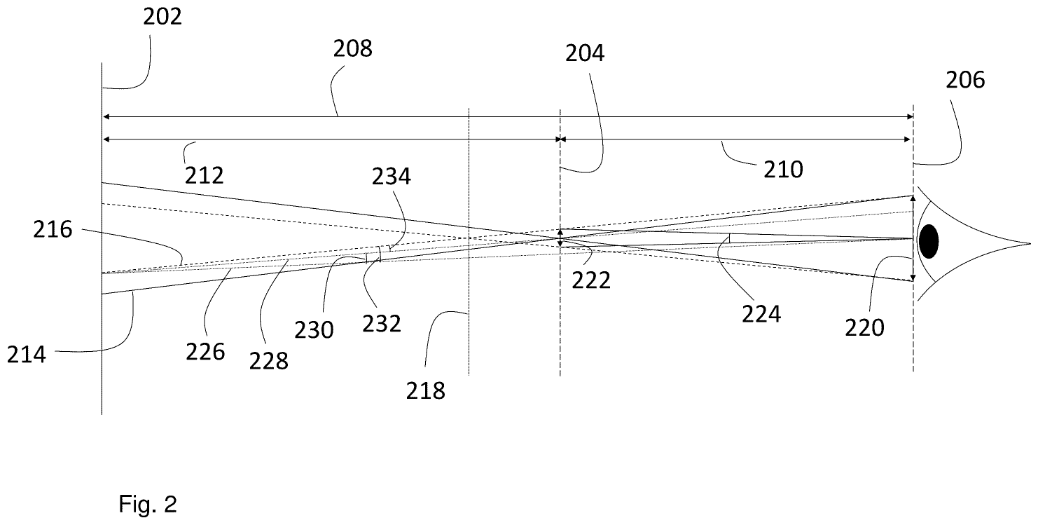

The analysis for θₜₑₘₚₒᵣₐₗ, the contribution to angular PSF due to a finite source bandwidth, Δλ, is similar. FIG. 2 shows a generic viewing scheme for a CGH display. As per the temporal bandwidth analysis, the display comprises: an image of an SLM, 202; a virtual image point that is viewed as part of the displayed image, the point being in a plane 204; and a viewer, viewing from a plane 206. The image of the SLM is at some distance, d_{SLM}, from the viewer, shown as 208; a virtual image point is at distance from the viewer, d_{obj}, shown as 210. The distance between the re-imaged SLM and a virtual object, Δd is also shown, shown as 212.

Light rays 214, drawn as solid lines, for an image point a distance d_{obj}, from the viewer, displayed at the nominal design wavelength, λ. Light rays 214 converge on the plane 204. A second set of light rays 216, drawn as dashed lines, correspond to light receiving the same phase modulation at the SLM, but having a different wavelength, λ′=λ+Δλ. Due to the difference in wavelength, the rays 216 converge on a different plane shown as 218. Note that the scales are adjusted for clarity; in reality the distance 210 of the virtual image point from the viewer is likely to be at least 100 times greater than the distance 220, meaning that the rays 214 and 216 are close to being congruent.

The extent of the rays at the design wavelength are defined by the width of a limiting aperture, w_{eyebox}, shown as 220. This aperture is likely to be an image of a spatial filter in the display apparatus, rather than a physical aperture in the plane of the eye. However, in the case where the eyebox (positions in which the image can be viewed) is larger than the viewer's pupil, the width of the pupil may be considered as the limiting aperture.

In the plane of the object, 204, the rays 216 define some width, wₜₑₘₚₒᵣₐₗ, shown as 222. This in turn defines θₜₑₘₚₒᵣₐₗ, the contribution to the overall angular PSF due to the limited temporal coherence of the source, shown as 224.

226 and 228 show construction lines for calculating θₜₑₘₚₒᵣₐₗ. 226 is a line from the image of the SLM to the centre of the eyebox, and 228 is a ray passing through the image point in the plane 204. 226 represents a ray that has zero focal power from the SLM (i.e., an image point in the plane of the SLM), and 228 shows a ray starting from the same point at the SLM but deflected to contribute to the object point in the plane 204. The angular deflection at the design wavelength Δθ is shown as 230. At the different wavelength λ′, the deflection angle Δθ′, shown as 232, is altered. The difference in deflection angle due to spectral bandwidth, δθ=Δθ′−Δθ, is shown as 234. For small angles, diffraction angle is proportional to wavelength, so δθ=ΔθΔλ/λ. It can also be seen that in the limit of 214 and 216 approaching congruence, Δθ=w_{eyebox}/(2d_{SLM}), so δθ=w_{eyebox} Δλ/(2d_{SLM}λ)

We can now proceed to calculate θₜₑₘₚₒᵣₐₗ. Once again working in the small-angle approximation, we can write:

$${θ}_{temporal} = {w}_{temporal} / {d}_{obj}$$

Substituting in our expression for δθ from above:

$${w}_{temporal} = 2 δ θ Δ {d}_{obj} = {w}_{eyebox} Δ {d}_{obj} Δ λ / ( {d}_{SLM} λ )$$

$$So$$

$${θ}_{temporal} = {w}_{eyebox} Δ {d}_{obj} Δ λ / ( {d}_{obj} {d}_{SLM} λ ) = {w}_{eyebox} D Δ λ / λ$$

Expressing this in terms of spectral bandwidth for a given θₜₑₘₚₒᵣₐₗ we obtain:

$$Δλ / λ = {θ}_{temporal} / ( D . {w}_{eyebox} ) \qquad ( 2 )$$

### Example System Designs

The above analysis is conducted without specific reference to SLM properties such as number of pixels or pixel pitch. This allows for powerful and easy analysis of designs based on user-facing specifications, such as angular resolution, field-of-view and eyebox size (the dimensions of the area where the image can be viewed).

In an example, image points are within some maximal absolute focal power of the image of the SLM, Dₘₐₓ, and additionally θₛₚₐₜᵢₐₗ and θₜₑₘₚₒᵣₐₗ are both required to be smaller than some target angular resolution, θᵣₑₛₒₗᵤₜᵢₒₙ. θᵣₑₛₒₗᵤₜᵢₒₙ can be thought of as the largest numerical value of angular resolution—that is to say, the worst angular resolution—that meets the design requirements for the display. In a display, θᵣₑₛₒₗᵤₜᵢₒₙ corresponds to the resolution that can be measured in use at the viewing position, for example.

This lets us rephrase (1) and (2) as the inequalities:

$$G \leq {θ}_{resolution} {θ}_{fov} / {D}_{max} \qquad ( 3 )$$

$$and$$

$$Δλ / λ \leq {θ}_{resolution} / ( {D}_{max} {w}_{eyebox} ) \qquad ( 4 )$$

### Examples 1 to 3—Specifying an Illumination Source

The following worked examples demonstrate the source coherence requirements for different display specifications following the analysis above. These examples start from the user-facing characteristics of the CGH display and use this to inform the choice of a suitable illumination source (or how the illumination source should be filtered for acceptable performance).

### Example 1

In a first example, a CGH display has the following properties:
The SLM is reimaged at 0.5 m from a viewer;
Virtual content is presented in the range 0.25 m to infinity (+−2 dioptres), giving Dₘₐₓ=2 dioptres.
The resolution, θᵣₑₛₒₗᵤₜᵢₒₙ, is 0.4 mrad (44 ppd/points per degree).
The eyebox width of 2.5 mm.
The horizontal field of view is 0.4 rad (23 degrees)

Applying these to inequalities (3) and (4) above results in G≤80 μm·rad and Δλ/λ ≤0.08. In this case an LED is likely to be appropriate, but one with a relatively small emitting area should be sourced. For example, collimating a central 0.4 rad (full width) emission cone allows for an emitter width of 200 μm. The spectral bandwidth requirement allows for broad LED emissions, although very spectrally broad LEDs based around fluorescent phosphors may need to be avoided. RGB LEDs are suitable candidates and can allow display of colour images through sequential display of component images. An example suitable RGB LED is the DISPLIX® P3333, KRTBLSLPS1.32 commercially available from Osram Opto Semiconductors.

### Example 2

In a second example, the CGH display has a smaller horizontal field of view and the eyebox is limited by the maximum size of a viewer's pupil. This has the following properties:
The SLM is reimaged at infinity.
Virtual content is displayed in the range 0.25 m to infinity, giving Dₘₐₓ=4 dioptres
the resolution, θᵣₑₛₒₗᵤₜᵢₒₙ, is set to typical human visual acuity, approx. 0.15 mrad (116 ppd).
The eyebox width is 7 mm (limited by the maximum size of the viewer's pupil)
The horizontal field of view is 0.17 rad (10 degrees).

Applying these to inequalities (3) and (4) above results in G≤6 μm·rad; Δλ/λ ≤0.005. In this case an LED would need to be filtered significantly to provide a low enough etendue and small enough spectral bandwidth, and the resulting efficiency is likely to be too low. However, a multimode laser could still be used, for example coupled into a 25 μm, 0.1 NA multimode fiber.

### Example 3

In a third example, a large horizontal field of view is required with a small eyebox and relatively low resolution. This has the following properties:
The SLM is reimaged 1 m from a viewer.
Virtual content is displayed in the range 0.5 m to infinity (+−1 diopters), giving Dₘₐₓ=1 diopters.
The resolution, θᵣₑₛₒₗᵤₜᵢₒₙ, is about 0.6 mrad (29 ppd).
The eyebox is 1 mm wide
The horizontal field of view is 1.0 rad (57 degrees).

Applying these to inequalities (3) and (4) above results in G≤600 μm·rad; Δλ/λ≤0.6. In this case, an LED with a relatively large (˜1 mm) emitting area may be used, together with a low f condenser lens (or possibly no condenser lens) coupling a large emission angle. The spectral bandwidth requirement poses no practical limitation, and a broadband LED based on a fluorescent phosphor may be used.

### Examples 4 to 7—Designing a CGH Display for a Particular Illumination Source

The skilled person is able to design CGH display systems to give predefined user-facing specifications as defined in equations (3) and (4) above. This presents an alternative way to use this disclosure; to design a CGH display system starting from a chosen illumination source. For example, a particular illumination source may have a particular desired wavelength (or wavelengths), or it may be desired to increase efficiency by reducing a level of filtering without unduly reducing resolution.

### Example 4—Compact RGB LED

The Osram OSIRE® E3323, KRTBDWLM32.32 commercially available from Osram Opto Semiconductors has individually controllable RGB dies in a compact package. Its form factor, luminous flux and power consumption are appropriate for an untethered Head Mounted Device (HMD) (approximately 1 lumen at approximately 100 mW). From the data sheet (English version 1.1 2020 Nov. 25) the following parameters are obtained: λₚₑₐₖ=635 nm, 526 nm, 456 nm; Δλ=20 nm; 31 nm; 26 nm (FWHM); approximately 0.25 mm×0.25 mm emitter size (separate die per colour, each approximately this size); approximately a Lambertian emitter. It is assumed that a central 1 radian full-width cone is collimated for illumination of the SLM. This gives G=250 μm·rad and Δλ/λ=0.031; 0.059; 0.057 (R;G;B)

It is now possible set the other parameters of the system to fit this source through inequalities (3) and (4) above. For example:
Dₘₐₓ≈1.5 dioptres (SLM reimaged at ˜67 cm from eye; content displayed between ˜33 cm and infinity)
FoV≈50 degrees
Resolution≈40 ppd (points per degree); θᵣₑₛₒₗᵤₜᵢₒₙ≈0.4 mrad
Eyebox≈5 mm

### Example 5—High Power, High Bandwidth LED

The M565D2 commercially available from Thorlabs is a high brightness, high power green LED. It likely uses a fluorescent emitter (a UV LED emitting into green phosphor) to achieve high power with the desired colour, resulting in a very broad spectral bandwidth. This is suitable for a tethered Head Mounted Display (HMD) requiring high brightness over a large FoV and limited focal depth (for example an aerospace HMD). From the datasheet (Sep. 27, 2019, MTN003919-S01, Rev D) the following information is obtained: λ=565 nm; Δλ=104 nm (FWHM); 1 mm×1 mm emitter size (assumed to be an approximately Lambertian emitter)

As with example 4, we assume a central 1 radian full-width cone is collimated for illumination of SLM. This gives G=1000 μm·rad; Δλ/λ=0.18

It is now possible set the other parameters of the system to fit this source through inequalities (3) and (4) above. For example:
Dₘₐₓ≈1 dioptre (SLM reimaged at ˜1 m from eye; content displayed between ˜50 cm and infinity)
FoV≈100 degrees
Resolution≈30 ppd; θᵣₑₛₒₗᵤₜᵢₒₙ≈0.6 mrad
Eyebox≈3 mm

### Example 6—Multimode Fiber-Pigtailed Laser Diode

The PL52E0252FCB-T commercially available from MKS Newport is likely formed from a single transverse mode emitter which has been coupled into a multimode fiber for improved efficiency (compared to coupling into a single mode fiber). In a CGH display, this is likely to be used with a de-speckler to act as a more uniform multimode source. In this example, the spectral bandwidth is assumed not to be a limitation (as the source is a laser so it can be assumed to be small to satisfy equation (2). However, equation (1) allows the relatively small source etendue to be used for high resolution even into a small Field of View (FoV). This may be useful to provide a high-quality display which occupies a small part of the overall field of view of a HMD, in much the same way that a watch—or smart watch—can provide useful information while only forming small part of the FoV. It might provide a display of time, status or other data. The status or other data could include exercise data, such as heart rate and number of steps, and motion data, such as current and average speed. From the datasheet (DS-072002_08/20) we learn that λ=520 nm; Δλ=˜1 nm (not specified but assumed to be typical for this type of laser); 50 μm 0.2 NA fiber. This gives G=20 μm·rad; Δλ/λ=0.002

It is now possible set the other parameters of the system to fit this source through inequalities (3) and (4) above. For example:
Dₘₐₓ≈2 dioptres (SLM reimaged at ˜50 cm from eye; content displayed between ˜25 cm and infinity)
FoV≈10 degrees
Resolution≈80 ppd; θᵣₑₛₒₗᵤₜᵢₒₙ≈0.2 mrad
Eyebox≈N/A (no limitation imposed by spectral bandwidth)

### Example 7—Superluminescent LED (SLED or SLD)

The EXS210115-00, commercially available from Exalos AG Switzerland is a single Transverse Mode source with broad spectral emission (compared to a laser). As with the laser of example 6, it could be coupled into a multimode fiber, but the broad spectral bandwidth would avoid the requirement for additional de-speckling. From the Exalos website (https://www.exalos.com/sled-modules/) it has the following properties: λ=510 nm; Δλ=10 nm; single transverse mode. This gives G=λ=0.51 μm·rad (single transverse mode); Δλ/λ=0.02

It is now possible set the other parameters of the system to fit this source through equations (1) and (2) above. For example:
Dₘₐₓ≈1.5 dioptre (SLM reimaged at ˜67 cm from eye; content displayed between ˜33 cm and infinity)
FoV≈N/A (no limitation due to single transverse mode)
Resolution≈80 ppd; θᵣₑₛₒₗᵤₜᵢₒₙ≈0.2 mrad
Eyebox≈7 mm (i.e., to match largest expected pupil size)

### Example Computer—Generated Hologram Display System

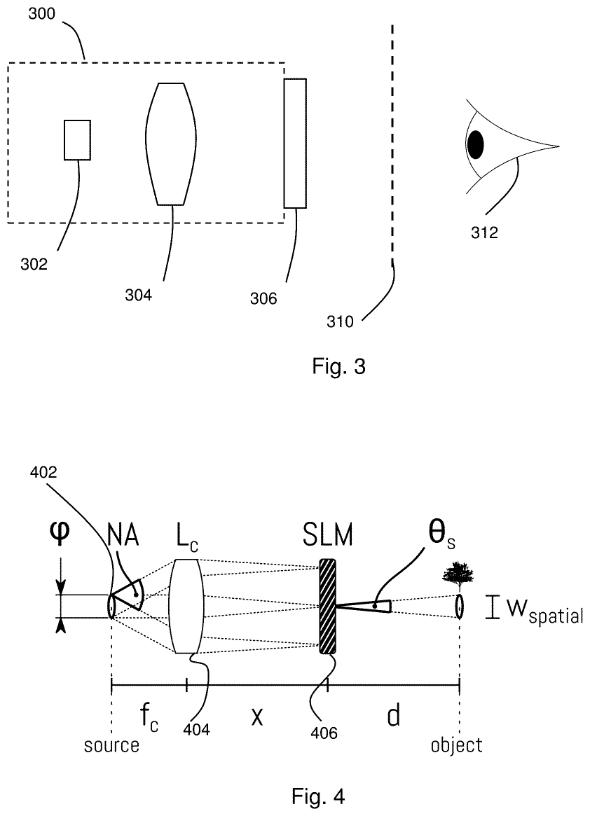

An example computer-generated hologram (CGH) display system that can be used with the principles of this disclosure is depicted in diagrammatic form in FIG. 3.

The CGH display system comprises an illumination system 300, and an SLM 306. The illumination system 300 comprises an illumination source 302 and illumination optics 304, in this case comprising a collimating lens.

Light from the illumination source 302 passes through the illumination optics 304 before illuminating a spatial light modulator (SLM) 306. Light incident on the SLM has an etendue G, spectral bandwidth Δλ and nominal wavelength λ. After the SLM 306, light forms an image plane 310, some distance from a viewing position of a viewer's eye 312. A characteristic of such a display system is that the SLM is re-imaged into an image plane 310 a distance from a viewer's pupil, and it is a maximum focal power of a virtual point displayed relative to the image plane 310 that sets a limit on the acceptable properties of the illumination system.

FIG. 3 is a simplified representation, and further examples may have additional components, such as a relay lens discussed in more detail below with reference to FIG. 6. Although FIG. 3 depicts a transmissive SLM for clarity, the present disclosure applies equally to reflective SLMs. Furthermore, the skilled person will appreciate that the present disclosure can be applied generally to CGH displays that reimage the SLM a distance from the viewing position, and is not limited to the particular form of FIG. 3.

### Relationship to SLM Parameters

The discussion so far has been independent of the SLM. Often, but not necessarily, the target resolution will be related to the field of view or eyebox size. If the resolution of a display matches the pixel size of the SLM then we can write:

$${θ}_{resolution} = {θ}_{fov} / n$$

where n is the number of pixels across an SLM. Equating θᵣₑₛₒₗᵤₜᵢₒₙ with θₛₚₐₜᵢₐₗ and substituting into equation (1) we can then write:

$$G \leq n {θ}_{resolution}^{2} / {D}_{max}$$

Additionally, If the SLM is relayed to the eye by a lens of focal length fᵣ, then θᵣₑₛₒₗᵤₜᵢₒₙ=p/fᵣ, where p is the pixel pitch of the SLM, and

$$G \leq n {p}^{2} / ( {D}_{max} {f}_{r}^{2} )$$

If the source is an extended source, width ϕ, collimated by a lens having focal length f_{c}, then the angular extent of the source required to fill the SLM is given by np/f_{c}. Substituting in G=ϕnp/f_{c} gives us:

$$ϕ / {f}_{c} \leq p / ( {D}_{max} {f}_{r}^{2} )$$

Assuming 1/fᵣ>>Dₘₐₓ, we can write dₘₐₓ=Dₘₐₓfᵣ², where dₘₐₓ is the maximum distance from the SLM that an image point is formed, and hence write:

$${0}_{s} \leq p / {d}_{max} \qquad ( 5 )$$

where θₛ=ϕ/f_{c} is the angular subtense of the source at the SLM.

Similarly for temporal coherence, often the target resolution of a display is determined by the diffraction-limited resolution of a given eyebox size, according to the relationship:

$${θ}_{resolution} = λ / {w}_{eyebox}$$

Equating θᵣₑₛₒₗᵤₜᵢₒₙ with θₛₚₐₜᵢₐₗ and substituting into (2) we can then write:

$$Δ λ \leq {θ}_{resolution}^{2} / {D}_{max}$$

Again, using the substitutions θᵣₑₛₒₗᵤₜᵢₒₙ=p/fᵣ and dₘₐₓ=Dₘₐₓfᵣ² we can then write:

$$Δ λ \leq {p}^{2} / {d}_{max} \qquad ( 6 )$$

### Further Discussion Considering SLM Properties

In the following sections, additional analysis considering contributions to a point spread function (PSF) of the display system is presented. From this, constraints on characteristics of an illumination system can be defined qualitatively to assist choice of illumination source within the illumination system. A width of the combined point spread function of the display system (w_{PSF}) has contributions from the angular subtense of the source at the SLM (wₛₚₐₜᵢₐₗ), the source's spectral bandwidth (wₜₑₘₚₒᵣₐₗ), and the inherent SLM resolution (w_{SLM}). These contributions to the width are additive according to the following relation:

$${w}_{PSF} = \sqrt{{w}_{{SLM}^{2}} + {w}_{{spatial}^{2}} + {w}_{{temporal}^{2}}} \qquad ( 7 )$$

In the display systems discussed here, the illumination system is designed so that neither of the coherence-related factors (wₛₚₐₜᵢₐₗ and wₜₑₘₚₒᵣₐₗ) are the dominant effect on resolution as represented by w_{PSF}, so the following constraints are used:

$${w}_{spatial} \leq {w}_{SLM} \qquad ( 8 )$$

$${w}_{temporal} \leq {w}_{SLM}$$

The inherent SLM resolution, w_{SLM}, depends on the nature of the display system. Where the full extent of the SLM is used directly, w_{SLM} can be approximated to a pixel pitch of the SLM, p. In other cases, spatial filtering after the SLM can reduce inherent resolution, for example to twice the pixel pitch, 2p. From the inequalities in (8), a larger value of w_{SLM} means that the contribution from the illumination system characteristics can be greater. It will be appreciated that although two constraints may be applied to the illumination system, other examples may apply other numbers of constraints, such as a single one.

Transverse Coherence Width (wₛₚₐₜᵢₐₗ)

Referring to FIG. 4, the elements of the display system design that contribute to wₛₚₐₜᵢₐₗ are illustrated. An illumination system 402, has a source diameter φ and a numerical aperture NA. (The numerical aperture is a measure of the divergence of the source). Light from the illumination system 402 passes through a collimating lens 404 having a focal length f_{c} to substantially collimate the light when it is incident on the SLM 406. As can be seen in FIG. 4, the collimating lens may not lead to light being exactly parallel, it might be slightly converging (as shown) or slightly diverging, so that the light from the source substantially illuminates the SLM with minimal “wasted” light outside the SLM, to improve efficiency.

Light incident on the SLM 406 has an angular subtense θs which is not necessarily the same as the numerical aperture, NA, of the source 402. Using the small angle approximation,

$${θ}_{s} \approx \frac{φ}{{f}_{c}} .$$

In general, at a distance d from the SLM, the transverse coherence width is related to the angular subtense of the source at the display θs and the displayed contents' axial distance from the SLM, d:

$${w}_{spatial} \approx d {θ}_{s} \approx \frac{d φ}{{f}_{c}} \qquad ( 9 )$$

Temporal Coherence Width (wₜₑₘₚₒᵣₐₗ)

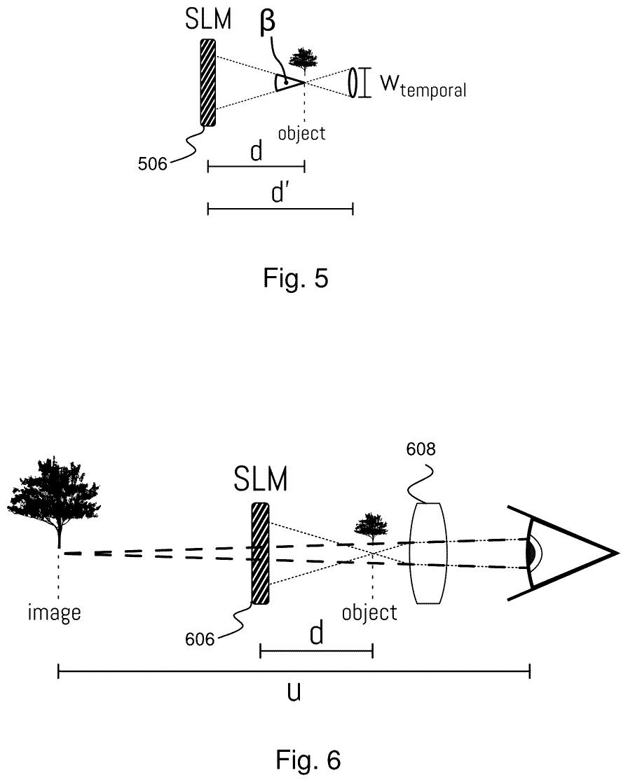

Referring to FIG. 5, the elements of the display system design that contribute to the temporal coherence width, wₜₑₘₚₒᵣₐₗ, are illustrated. Light leaving the SLM 506 is limited in terms of how much it can be brought into a singular focus by the spectral band of the illumination system.

The temporal coherence of the illumination system determines the degree to which a spectral band from the source (Δλ, centred on λ) can be brought to a singular focus at an axial distance from the SLM(d).

This is bounded by the maximum diffraction angle achievable from the SLM (β) and pixel pitch (p) by the standard equation for a blazed grating:

$$p ( sin α + sin β ) = m λ \qquad ( 10 )$$

where α is the incidence angle, which can be assumed to be zero because light incident on the SLM is generally collimated, and m is the diffraction order, taken as 1 in this case. From this, and applying the small angle approximation, it follows that:

$$β = {sin}^{- 1} ( \frac{λ}{p} ) \approx \frac{λ}{p} \qquad ( 11 )$$

This the informs the value of wₜₑₘₚₒᵣₐₗ:

$${w}_{temporal} \approx ( \frac{d - {d}^{′}}{{d}^{′}} ) \qquad ( 12 )$$

$$d β = \frac{Δ λ d}{p}$$

$$( where \frac{{d}^{′}}{d} = \frac{λ}{{λ}^{′}} , {λ}^{′} = λ + Δλ )$$

here λ′ is the wavelength corresponding to d′, and d′ represents the out-of-focus components of in the bundle of wavelengths.

### Relay Lens

FIG. 6 is a diagrammatic action of a relay lens. An output relay lens 608 (with focal length fᵣ) maps object space to image space, which scales axial distance from the SLM 606. Some embodiments may omit the relay lens but, when it is included, it can be useful to ensure that content (imaged at a real distance dₘₐₓ from the SLM) is not placed within the viewer's near point (zₘᵢₙ, the nearest point that an eye can bring into focus, typically about 25 cm and closer). The relay lens allows a limit to be placed on dₘₐₓ for the design of the system but the characteristics of the lens itself cancel out from the calculations. Nonetheless, the relay lens allows dₘₐₓ to be made smaller, which is beneficial for the system because a smaller value of dₘₐₓ allows wider spectral bandwidth and angular subtense in the light leaving the SLM, so that a broader variety of possible light sources can be used.

$$\frac{1}{{f}_{r}} = \frac{1}{u} - \frac{1}{{z}_{min}} ⇒ u = \frac{{f}_{r} {z}_{min}}{{f}_{r} + {z}_{min}} \qquad ( 13 )$$

$${d}_{max} = {f}_{r} - u = {f}_{r} - \frac{{f}_{r} {z}_{min}}{{f}_{r} + {z}_{min}} = \frac{{f}_{r}^{2}}{{f}_{r} + {z}_{min}}$$

$${f}_{r} \approx \frac{np}{{θ}_{FOV}}$$

where fᵣ is the focal length of the relay lens, zₘᵢₙ is a minimum focal distance of a viewer, u is the distance from the viewer to the reimaged SLM, n is the number of pixels/points in a given axis (for example, 1920 in the horizonal axis for a 1080p display) and θ_{FOV} is the field of view of the viewer.

### System Design Using SLM Properties

We can now determine the constraints on the system as follows

$$Spatial coherence limit -$$

$$\frac{{d}_{max} ϕ}{{f}_{c}} \leq p ⇒ ϕ \leq \frac{p {f}_{c}}{{d}_{max}} and / or {θ}_{s} \leq \frac{p}{{d}_{max}} \qquad ( 14 )$$

$$Temporal coherence limit -$$

$$\frac{Δ λ {d}_{max}}{p} \leq p ⇒ Δ λ \leq \frac{{p}^{2}}{{d}_{max}} \qquad ( 15 )$$

Using this set of equations, it is now possible to determine quantitively characteristics of the illumination system spectral bandwidth, diameter, and/or angular subtense in a way not previously possible with reference to the properties of the CGH display system and the SLM. Suitable illumination sources can be selected based on cost, brightness, efficiency or other factors with knowledge that acceptable image sharpness will be achieved. While it remains the case that not all LEDs, for example, are suitable, it is possible to select suitable LEDs for a particular system design with confidence.

Method of Defining a Suitable Light Source when SLM Properties are Considered

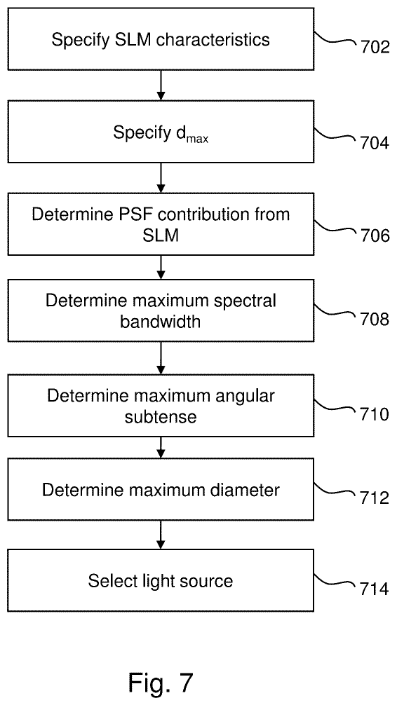

FIG. 7 depicts a method of selecting a suitable light source for a computer-generated hologram display system according to an example using the analysis considering SLM properties discussed above. Although the blocks in FIG. 7 are depicted sequentially, the method is not limited to this order and block may be carried out in a different order and/or in parallel in other examples.

First, the optical system is designed, or parameters of an existing CGH display system are gathered. At 702, details of a spatial light modulator (SLM) having a pixel pitch is specified or gathered from the datasheet of the SLM. At 704 a predetermined maximum distance at which the SLM will be re-imaged in use is specified. Other characteristics of the design may also be specified, such as a collimating lens focal length and/or a focal length of a relay lens, if included.

With the system design known, at 706 a contribution to a point spread function (PSF) by the SLM at the predetermined maximum distance is determined. For example, this may simply be the pixel pitch assuming that incident light is substantially collimated when illuminating the SLM and so generally remains substantially collimated after leaving the SLM. This contribution to a PSF is used as a constraint to determine a maximum spectral bandwidth of the illumination system based on the predetermined maximum distance at 708, such as by applying equation (15) above. A maximum angular subtense leaving the SLM is determined at 710 based on the predetermined maximum distance and using the contribution to the point spread function by the SLM at the predetermined maximum distance as a constraint, for example by applying equation (14) above for θs. At 712, a maximum diameter of the light source is determined, such as by applying equation 8 above for Φ. Some examples may use one, two or all three of the determinations at 708, 710 and 712, the more that are used the tighter the criteria for the light source and the higher the image quality. Specifying angular subtense θs and Φ may be useful when the angular subtense after the SLM is not the same as the numerical aperture of the source.

Finally, at 714, a light source is selected for an illumination system based on the determined characteristics.

It can be understood that the method of FIG. 7 can be used to qualitatively inform selection of a light source for good image quality. In other examples, the design of a CGH display system may itself be influenced, such as to allow a wider choice of light sources, or to allow a particular light source to be used. For example, it might be desired to use a Superluminescent LED to achieve a high luminance, and knowledge of the spectral bandwidth could influence the other variables of the display system, such as determining a value for dₘₐₓ that allows sufficient spectral bandwidth for the source to be used.

Other design methods may be used in other examples. For example, the design of CGH display systems in Examples 1 to 7 above started with user facing properties of the CGH system independent of the SLM, or properties of the illumination system in terms of etendue and/or spectral bandwidth.

The above embodiments are to be understood as illustrative examples of the invention. Further embodiments of the invention are envisaged. For example, while the system includes a collimating lens, this may not be required if the numerical aperture of the source is sufficiently small. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-generated holographic display system having an angular resolution and an angular field of view at a viewing position, the computer-generated holographic display system comprising:
an illumination system comprising an LED or multimode laser;
an SLM illuminated by the illumination system; and
an optical system configured to reimage the SLM at a predetermined distance from the viewing position;
wherein:
the illumination system has an etendue at the SLM which is less than or equal to a product of the angular resolution at the viewing position and the angular field of view at the viewing position divided by a maximum focal power of a virtual image point with respect to the reimaged SLM; and
the angular resolution is less than about 1 mrad.

2. The computer-generated holographic display system according to claim 1, wherein the viewing position is a position of a viewer's pupil in use.

3. The computer-generated holographic display system according to claim 1, wherein the illumination system has an etendue greater than 2% of a product of the angular resolution and the angular field of view divided by a maximum focal power of a virtual image point with respect to the reimaged SLM.

4. The computer-generated holographic display system according to claim 1, wherein the illumination system comprises an angular filter which at least partially sets the source etendue of the illumination system.

5. The computer-generated holographic display system according to claim 1, wherein the illumination system comprises a spatial filter which at least partially sets the source etendue of the illumination system.

6. The computer-generated holographic display system according to claim 1, wherein the predetermined distance at which the SLM is reimaged is greater than a minimum distance of a virtual image point from the viewing position.

7. The computer-generated holographic display system according to claim 1 wherein the maximum focal power corresponds to a virtual image point less than or equal to about 1 m from the viewing position.

8. The computer-generated holographic display system according to claim 1, wherein the maximum focal power corresponds to a virtual image point approximately 0.25 m from the viewing position.

9. The computer-generated holographic display system according to claim 1, wherein the maximum focal power is less than or equal to about 3 dioptres.

10. The computer-generated holographic display system according to claim 1, wherein the angular resolution is greater than about 0.15 mrad.

11. The computer-generated holographic display system according to claim 1, wherein:
the computer-generated holographic display system has a limiting aperture width;
the illumination system has a spectral bandwidth and a nominal wavelength; and
the spectral bandwidth divided by the nominal wavelength is less than or equal to the angular resolution divided by the product of the maximum focal power and the limiting aperture width.

12. The computer-generated holographic display system according to claim 11, wherein the limiting aperture width is less than about 7 mm.

13. The computer-generated holographic display system according to claim 1, wherein:
the illumination system has a spectral bandwidth and a nominal wavelength; and
the spectral bandwidth divided by the nominal wavelength is less than or equal to the angular resolution divided by the product of the maximum focal power and 7 mm.

14. A computer-generated holographic display system having an angular resolution at a viewing position and a limiting aperture width, the computer-generated holographic display system comprising:
an illumination system comprising an LED or multi-mode laser and having a spectral bandwidth and a nominal wavelength;
an SLM illuminated by the illumination system; and
an optical system configured to reimage the SLM at a predetermined distance from the viewing position;
wherein:
the spectral bandwidth divided by the nominal wavelength is less than or equal to the angular resolution divided by the product of the limiting aperture width and a maximum focal power of a virtual image point with respect to the reimaged SLM; and
the angular resolution is less than about 1 mrad.

15. A computer-generated holographic display system having an angular resolution at a viewing position, the computer-generated holographic display system comprising:
an illumination system comprising an LED or multi-mode laser and having a spectral bandwidth and a nominal wavelength;
an SLM illuminated by the illumination system; and
an optical system configured to reimage the SLM at a predetermined distance from the viewing position;
wherein:
the spectral bandwidth divided by the nominal wavelength is less than or equal to the angular resolution divided by the product of a maximum focal power of a virtual image point with respect to the reimaged SLM and 7 mm; and
the angular resolution is less than about 1 mrad.
